(19) United States
(12) Patent Application Publication
(10) Pub. No.: US 2025/0167203 A1
(43) Pub. Date: May 22, 2025

(54) SOLID-STATE CATHODE COMPOSITION

(71) Applicant: Solid Power Operating, Inc., Louisville, CO (US)

(72) Inventors: Jason ROBERTS, Denver, CO (US); Stephanie Young, Louisville, CO (US); Alexandra Bothwell, Boulder, CO (US); Omar Chaarawi, Boulder, CO (US); Nathan Dunlap, Golden, CO (US); Joshua Buettner-Garrett, Arvada, CO (US)

(21) Appl. No.: 18/954,405

(22) Filed: Nov. 20, 2024

Related U.S. Application Data
(60) Provisional application No. 63/601,149, filed on Nov. 20, 2023.

(51) Int. Cl. H01M 4/131; H01M 4/02; H01M 4/525; H01M 10/0562

(52) U.S. Cl. CPC H01M 4/131; H01M 4/525; H01M 10/0562; H01M 2004/028; H01M 2300/008

(57) ABSTRACT

The present disclosure provides cathode compositions comprising solid-state electrolytes and cathode active materials. The cathode active materials may be single crystal, polycrystalline, or a combination thereof. The present disclosure also relates to cathodes made from the cathode composition.

### CROSS-REFERENCE TO RELATED APPLICATION

This application is related to and claims priority under 35 U.S.C. § 119 (e) from U.S. Patent Application No. 63/601,149, filed Nov. 20, 2023, entitled “Solid-State Cathode Composition,” the entire contents of which is incorporated herein by reference for all purposes.

### TECHNICAL FIELD

This disclosure generally relates to a cathode composition comprising solid-state electrolytes and cathode active materials. The solid-state electrolytes include sulfide solid-state electrolytes including but not limited to argyrodite-type electrolytes. The cathode active materials may be single-crystal, polycrystalline, or a combination thereof.

### BACKGROUND

Improved safety is a touted advantage of solid-state batteries as the volatile liquid electrolyte is replaced with more stable solid materials, but the specific material combinations used have a large impact on the safety characteristics regardless of whether the system is liquid or solid. In particular, sulfide solid-state electrolytes (SSE) (e.g., Argyrodite Li₆PS₅Cl) tend to react exothermally at high temperatures with commonly used cathode materials such as nickel, manganese, and cobalt (NMC) with the amount of energy released proportional to the state-of-charge (SOC) of the cathode.

The present disclosure relates to a cathode comprising a combination of single-crystal, polycrystalline, or a single-crystal and polycrystalline blend cathode active material (CAM) and sulfide solid-state electrolytes. The sulfide electrolyte may be a high-halogen electrolyte.

### SUMMARY

The present disclosure is directed to a cathode composite composition comprising a single-crystal cathode active material and a polycrystalline cathode active material. The present disclosure further relates to a cathode comprising one or more solid electrolyte materials, wherein the one or more solid electrolyte is a solid sulfide electrolyte comprising the formula Li_{7-y}PS_{6-y}X_{y}, where 0≤y≤2 and X is halogen, and halogen comprises F, Cl, Br, or I.

In some embodiments, the solid sulfide electrolyte may be Li₆PS₅Cl. In other embodiments, the solid sulfide electrolyte may be Li_{5.7}PS_{4.7}Cl₁₋₃. In other embodiments, the solid sulfide electrolyte may be Li_{5.5}PS_{4.5}Cl_{1.5}. In yet other embodiments, the solid electrolyte material may be an argyrodite electrolyte.

In some embodiments, the single-crystal cathode active material may be monolithic.

In some embodiments, the cathode composite composition may have a heat flow of 2.5 W/g or less between 275° C. and 325° C. when measured by DSC. In some embodiments, the cathode composite composition may have a heat flow of 1.5 W/g or less between 275° C. and 325° C. when measured by DSC. In other embodiments, the cathode composite composition may have a heat flow of 1.3 W/g or less between 275° C. and 325° C. when measured by DSC. In some embodiments, the cathode composite composition may have a heat flow of 1.0 W/g or less between 275° C. and 325° C. when measured by DSC.

In some embodiments, the cathode composite composition may have an ionic conductivity of at least 2 mS/cm. In other embodiments, the cathode composite composition may have an ionic conductivity of at least 3 mS/cm. In some embodiments, the cathode composite composition may have an ionic conductivity from about 3 mS/cm to about 6 mS/cm.

In some embodiments, the cathode composite composition may partially re-lithiate at a temperature of about 150° C. and about 300° C. In some embodiments, the cathode composite composition may further include Al₂O₃.

In some embodiments, the cathode composite composition may have a capacity of greater than 130 mAh/g.

In some embodiments, the cathode composite composition may have an enthalpy from about 500 J/g to about 750 J/g at a temperature of between about 120° C. to about 350° C. and a 100% state of charge (SOC). In some embodiments, the cathode composition may have an enthalpy from about 500 J/g to about 600 J/g at a temperature of between about 120° C. to about 350° C. and a 100% state of charge (SOC).

In some embodiments, the cathode composite composition may have an enthalpy from about 525 J/g to about 575 J/g at a temperature of between about 120° C. to about 350° C. and a 100% state of charge (SOC).

In some embodiments, the cathode composite composition may have an enthalpy from about 530 J/g to about 570 J/g at a temperature of between about 120° C. to about 350° C. and a 100% state of charge (SOC).

In some embodiments, the cathode composite composition comprising the solid sulfide electrolyte with y≥0.25 may have a higher onset temperature relative to a composition consisting of a solid sulfide electrolyte with y=0.

In some embodiments, the cathode composite composition may include a blend of solid sulfide electrolyte. In some embodiments, the blend may include two or more solid-state electrolytes with different values of y.

In some embodiments, the ratio of single crystal cathode active material to polycrystalline cathode active material may be from about 20:1 to about 1:20, from about 10:1 to about 1:10, from about 5:1 to about 1:5, from about 4:1 to about 1:4, from about 3:1 to about 1:3, from about 2:1 to about 1:2, from about 1.5:1 to about 1:1.5, from about 1.3:1 to about 1:1.3, from about 1.2:1 to about 1:1.2, from about 1.1:1 to about 1:1.1, or about 1:1.

In some embodiments, the cathode composite composition may be a blend of single-crystal cathode active material and polycrystalline cathode active material, and the polycrystalline cathode active material may have a higher onset temperature relative to a composition consisting of the single-crystal electrolyte.

In some embodiments, the cathode composite composition includes a blend of single-crystal cathode active material and polycrystalline cathode active material may have a higher onset temperature relative to a composition consisting of the single-crystal electrolyte or the polycrystalline cathode active material individually at 50% state of charge.

In some embodiments, the cathode composite composition including a blend of the single-crystal cathode active material, and the polycrystalline cathode active material may have a lower peak heat flow relative to the composition consisting of the single-crystal cathode active material or the polycrystalline cathode active material individually at 100% state of charge.

In some embodiments, the cathode active material further includes nickel. In other embodiments, the nickel may be a nickel compound including but not limited to a nickel compound of the formula LiNiₐMn_{b}Co_{c}O₂ where 0<a<1, 0<b<1, 0<c<1 and a+b+c=1. In some embodiments, the nickel compound may be NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof.

The present disclosure further relates to the cathode composite composition as described above.

The present disclosure further related to an electrochemical cell with the cathode composite composition as described above.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 shows plots of heat flow versus temperature according to some embodiments of the present disclosure.

FIG. 2 shows plots of heat flow versus temperature according to some embodiments of the present disclosure.

FIGS. 3A-3D show enthalpy of cathode composites that were at 50% state of charge (FIGS. 3A and 3B) and 100% state of charge (FIGS. 3C and 3D) respectively according to some embodiments of the present disclosure.

FIGS. 4A-4D show enthalpy of cathode composites that were at 50% state of charge (FIGS. 4A and 4B) and 100% state of charge (FIGS. 4C and 4D) respectively according to some embodiments of the present disclosure.

### DETAILED DESCRIPTION

In the following description, specific details are provided to impart a thorough understanding of the various embodiments of the disclosure. Upon having read and understood the specification, claims, and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

This present disclosure is directed to a cathode composition comprising solid-state electrolytes and cathode active materials. The solid-state electrolytes include sulfide solid-state electrolytes including but not limited to argyrodite-type electrolytes. The cathode active materials may be single-crystal, polycrystalline, or a combination thereof. The combination may be a blend of single-crystal and polycrystalline cathode active materials.

The present disclosure also discloses that the total change in enthalpy associated with the electrolyte-cathode reaction may be substantially lower with single-crystal or monolithic type layered oxide cathode materials compared to conventional polycrystalline cathode active materials (CAM). The mechanism is not yet fully understood, but it may be tied to improved structural stability and the nature of the oxygen release from the CAM. The single-crystal material also appears to partially re-lithiate at moderately high temperatures which lowers its effective SOC and may render it more stable. Single-crystal materials may have incremental safety advantages with liquid electrolytes. The safety advantages may be more pronounced with a combination of the single-crystal and solid sulfide electrolyte or blend of single-crystal and polycrystalline and solid sulfide electrolyte.

The present disclosure further discloses that the use of sulfide electrolytes with higher halogen content may delay the temperature onset of self-heating which may further improve the safety profile of the solid-state cell. The mechanism is not yet clear but may be tied to one or more of total sulfur and halogen content, structural stability, and/or impurity profile.

### I) A Cathode Composite Composition

The current disclosure provides a cathode composite composition comprising a single-crystal cathode active material, a polycrystalline cathode active material, or a combination thereof. The cathode composite composition further includes a solid-state electrolyte.

### i) Cathode Active Material

In some embodiments of the present disclosure, the cathode active material may be a single-crystal cathode active material, a polycrystalline cathode active material, or a combination thereof.

In some embodiments, the ratio of single-crystal cathode active material to polycrystalline cathode active material may be from about 20:1 to about 1:20, from about 10:1 to about 1:10, from about 5:1 to about 1:5, from about 4:1 to about 1:4, from about 3:1 to about 1:3, from about 2:1 to about 1:2, from about 1.5:1 to about 1:1.5, from about 1.3:1 to about 1:1.3, from about 1.2:1 to about 1:1.2, from about 1.1:1 to about 1:1.1, or about 1:1.

The cathode active material may include material such as nickel-manganese-cobalt (NMC) which can be expressed as Li(NiₐCo_{b}Mn_{c})O₂ (0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-y}Co_{y}O₂, LiCo_{1-y}Mn_{y}O₂, LiNi_{1-y}Mn_{y}O₂ (0<Y<I), Li(NiₐCo_{b}Mn_{c})O₄ (0<a<2, 0<b<2, 0<c<2, a+b+c=2), LiMn_{2-z}Ni₂O₄, LiMn_{2-z}Co₂O₄ (0<Z<2), LiCoPO₄, LiFePO₄, CuO, Li(NiₐCo_{b}Al_{c})O₂ (0<a<1, 0<b<1, 0<c<1, a+b+c=1) or a combination thereof. In yet another embodiment, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combination thereof.

### ii) Solid-State Electrolyte

In some embodiments, the cathode composite composition includes a solid-state electrolyte material. The solid electrolyte may be a solid sulfide electrolyte. The solid electrolyte material may be an argyrodite electrolyte.

In a further embodiment, the solid-state electrolyte may be one or more of a Li₆PS₅Cl, Li₆PS₅Br, Li₆PS₅I or expressed by the formula Li_{7-y}PS_{6-y}X_{y} where “X” represents at least one halogen elements and or pseudo-halogen and where 0<y<2.0 and where a halogen may be one or more of F, Cl, Br, I, and a pseudo-halogen may be one or N, NH, NH₂, NO, NO₂, BF₄, BH₄, AlH₄, CN, and SCN. In some embodiments, y may be about 0, about 0.10, about 0.15, about 0.20, about 0.25, about 0.30, about 0.35, about 0.40, about 0.45, about 0.50, about 0.55, about 0.60, about 0.65, about 0.70, about 0.75, about 0.80, about 0.85, about 0.90, about 0.95, about 1.00, about 1.05, about 1.10, about 1.15, about 1.20, about 1.25, about 1.30, about 1.35, about 1.40, about 1.45, about 1.50, about 1.55, about 1.60, about 1.65, about 1.70, about 1.75, about 1.80, about 1.85, about 1.90, about 1.95, or about 2.0. X may be F, Cl, Br, or I.

In some embodiments, the solid sulfide electrolyte may be Li₆PS₅Cl. In some embodiments, the solid sulfide may be Li_{5.7}PS_{4.7}Cl_{1.3}. In some embodiments, the solid sulfide may be Li_{5.5}PS_{4.5}Cl_{1.5}.

In yet another embodiment, the solid-state electrolyte be expressed by the formula Li_{8-y-z}P₂S_{9-y-z}X_{y}W_{z} (where “X” and “W” represents at least one halogen elements and or pseudo-halogen and where 0<y<1 and 0<z<1) and where a halogen may be one or more of F, Cl, Br, I, and a pseudo-halogen may be one or N, NH, NH₂, NO, NO₂, BF₄, BH₄, AlH₄, CN, and SCN.

The cathode composite composition may further comprise one or more solid sulfide electrolyte wherein the solid electrolyte comprises one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In another embodiment, the solid-state electrolyte may be one or more of a Li₃PS₄, Li₄P₂S₆, Li₇P₃S₁₁, Li₁₀GeP₂S₁₂, Li₁₀SnP₂S₁₂.

The solid sulfide electrolyte composition may include an argyrodite-type sulfide electrolyte. The argyrodite-type sulfide may be lithium argyrodite at about 75 wt % or greater. The percent of lithium argyrodite may be about 75 wt %, about 76 wt %, about 77 wt %, about 78 wt %, about 79 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, or about 100 wt %.

The solid sulfide electrolyte composition may include at least about 80 wt % of the lithium argyrodite and between about 0.01 wt % to about 20 wt % of Li₃PO₄. The solid-state electrolyte composition may include lithium argyrodite at least at about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, or about 100 wt %.

The solid-state electrolyte composition may include between about 0.01 wt % to about 20 wt % of Li₃PO₄. The solid-state electrolyte composition may include Li₃PO₄ at about 0.02 wt %, about 0.05 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt %.

The solid-state electrolyte composition may include between about 0.01 wt % to about 2.0 wt % of P₂S₅. The amount of P₂S₅ may be about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2.0 wt %.

The solid sulfide electrolyte composition may include between about 0.01 wt % to about 2.0 wt % of Li₂S. The amount of Li₂S may be about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2.0 wt %.

The solid sulfide electrolyte composition may include between about 0.01 wt % to about 10.0 wt % of LiCl. The amount of LiCl may be about 0.01 wt %, about 0.02 wt %, 0.03 wt %, 0.04 wt %, 0.05 wt %, 0.06 wt %, 0.07 wt %, 0.08 wt %, 0.09 wt %, 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4.0 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5.0 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6.0 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7.0 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, about 8.0 wt %, about 8.1 wt %, about 8.2 wt %, about 8.3 wt %, about 8.4 wt %, about 8.5 wt %, about 8.6 wt %, about 8.7 wt %, about 8.8 wt %, about 8.9 wt %, about 9.0 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, or about 10.0 wt %.

The solid sulfide electrolyte composition may include between about 0.01 wt % to about 10.0 wt % of Li₃PS₄, Li₇PS₆, Li₄PS₄I, Li_{5.5}PS_{4.5}ClBr_{0.5}, or a combination thereof. The amount of Li₃PS₄, Li—PS₆, Li₄PS₄I, Li_{5.5}PS_{4.5}ClBr_{0.5}, or a combination thereof may be about 0.01 wt %, about 0.02 wt %, 0.03 wt %, 0.04 wt %, 0.05 wt %, 0.06 wt %, 0.07 wt %, 0.08 wt %, 0.09 wt %, 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4.0 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5.0 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6.0 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7.0 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, about 8.0 wt %, about 8.1 wt %, about 8.2 wt %, about 8.3 wt %, about 8.4 wt %, about 8.5 wt %, about 8.6 wt %, about 8.7 wt %, about 8.8 wt %, about 8.9 wt %, about 9.0 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, or about 10.0 wt %.

In one embodiment, the solid-state electrolyte composition includes between 0.01% and 1.5% by weight P₂S₅, between 0.01% by weight Li₂S, and between 0.01% and 1.5% by weight Li₃PS₄, Li₇PS₆, Li₄PS₄I, Li_{5.5}PS_{4.5}ClBr_{0.5}, or a combination thereof wherein X is F, Cl, or Br.

In one embodiment, the cathode composition partially re-lithiates at a temperature of about 150° C. and about 300° C.

In some embodiments, the cathode composition further comprises Al₂O₃.

### II) Cathode Comprising the Cathode Composite Composition

In some embodiments, the cathode composite composition may be used to make a cathode.

The cathode may have a heat flow (measured in Watts/gram, W/g) of 2.5 W/g or less, 2.4 W/g or less, 2.3 W/g or less, 2.2 W/g or less, 2.1 W/g or less, 2.0 W/g or less, 1.9 W/g or less, 1.8 W/g or less, 1.7 W/g or less, 1.6 W/g or less, 1.5 W/g or less, 1.4 W/g or less, 1.3 W/g or less, 1.2 W/g or less, 1.1 W/g or less, 1.0 W/g or less, 0.9 W/g or less, 0.8 W/g or less, 0.7 W/g or less, 0.6 W/g or less, 0.5 W/g or less, 0.4 W/g or less, 0.3 W/g or less, 0.2 W/g or less, or 0.1 W/g or less between 275° C. and 325° C. when measured by Differential Scanning calorimetry (DSC).

The cathode may have an ionic conductivity of at least 2 mS. In some embodiments, the cathode may have an ionic conductivity of at least 3 mS. In some embodiments, the cathode may have an ionic conductivity from about 3 mS to about 6 mS.

The cathode may have a capacity (measured in milliampere-hours per gram, mAh/g) of greater than 130 mAh/g.

The cathode may have an enthalpy from about 500 J/g to about 750 J/g at a temperature of between about 120° C. to about 350° C. and a 100% state of charge (SOC). For example, the enthalpy may be about 500 J/g, about 510 J/g, about 520 J/g, about 530 J/g, about 540 J/g, about 550 J/g, about 560 J/g, about 570 J/g, about 580 J/g, about 590 J/g, about 600 J/g, about 610 J/g, about 620 J/g, about 630 J/g, about 640 J/g, about 650 J/g, about 660 J/g, about 670 J/g, about 680 J/g, about 690 J/g, about 700 J/g, about 710 J/g, about 720 J/g, about 730 J/g, about 740 J/g, or about 750 J/g at a temperature of between about 120° C. to about 350° C. and a 100% state of charge (SOC).

Argyrodite electrolytes (Li₅PS₅Cl or generically Li_{6-y}PS_{5-y}X_{1+y} where X═Cl, Br, or I, and 0≤y≤1) generally display increased reactivity as the halogen content is increased within the electrolyte. An increase in the halogen content from 1 as in Li₆PS₅Cl to 1.5 as in Li_{5.5}PS_{4.5}Cl_{1.5} may result in an increase in the ionic conductivity (measured in milliSiemens per centimeter, mS/cm) from 1 mS/cm to 6 mS/cm. For example, the ionic conductivity may be about 1.0 mS/cm, about 1.1 mS/cm, about 1.2 mS/cm, about 1.3 mS/cm, about 1.4 mS/cm, about 1.5 mS/cm, about 1.6 mS/cm, about 1.7 mS/cm, about 1.8 mS/cm, about 1.9 mS/cm, about 2.0 mS/cm, about 2.1 mS/cm, about 2.2 mS/cm, about 2.3 mS/cm, about 2.4 mS/cm, about 2.5 mS/cm, about 2.6 mS/cm, about 2.7 mS/cm, about 2.8 mS/cm, about 2.9 mS/cm, about 3.0 mS/cm about 3.1 mS/cm, about 3.2 mS/cm, about 3.3 mS/cm, about 3.4 mS/cm, about 3.5 mS/cm, about 3.6 mS/cm, about 3.7 mS, about 3.8 mS/cm, about 3.9 mS/cm, about 4.0 mS/cm, about 4.1 mS/cm, about 4.2 mS/cm, about 4.3 mS/cm, about 4.4 mS/cm, about 4.5 mS/cm, about 4.6 mS/cm, about 4.7 mS/cm, about 4.8 mS/cm, about 4.9 mS/cm, about 5.0 mS/cm about 5.1 mS/cm, about 5.2 mS/cm, about 5.3 mS/cm, about 5.4 mS/cm, about 5.5 mS/cm, about 5.6 mS/cm, about 5.7 mS/cm, about 5.8 mS/cm, about 5.9 mS/cm, or about 6.0 mS/cm. The ionic conductivity may range from about 1.0 mS/cm to about 6.0 mS/cm, about 2.0 mS/cm to about 5.0 mS/cm, or about 3.0 mS/cm to about 4.0 mS/cm. Using an electrolyte with a higher ionic conductivity may result in improved electrochemical performance of the resulting battery and/or cell. However, the electrolytes with higher ionic conductivities (i.e. higher halogen content) may have lower electrochemical stability (meaning they break down at lower voltages during charge/discharge) and may have higher reactivity to air/moisture (meaning they degrade faster when exposed to open air). Thus, using these higher halogen content electrolytes in the cathode may cause a more aggressive reaction with the NMC materials which would make the resulting battery and/or cell less safe (have a higher enthalpy and a lower Onset temperature to a thermal runaway).

Interestingly the present disclosure shows that an increase the halogen content of the electrolyte used in the cathode composite (use a “more reactive” electrolyte), may result in higher onset temperature and lower enthalpy (lower/less reactivity between the cathode active material and the electrolyte) when a single-crystal cathode active material is used.

The disclosure will now be illustrated with working examples, and which are intended to illustrate the disclosure and not intended to restrict any limitations on the scope of the present disclosure. Unless defined otherwise, all technical and scientific terms used herein have the same meaning as commonly understood to one of ordinary skill in the art to which this disclosure belongs.

### EXAMPLES

### Example 1—Single Crystalline Cathode Active Material and Poly-Crystalline Cathode Active Material

Lab-scale cells (pellet cells and small single-layer pouch cells) using a cathode active material, and various electrolytes were built for electrochemical characterization and thermal characterization by differential scanning calorimetry (DSC) and accelerating rate calorimetry (ARC). The cathode active material was single-crystal, polycrystalline, or a combination thereof. The electrolytes used had varying chloride content. The electrolytes used were Li₆PS₅Cl (Electrolyte 1) and Li_{5.7}PS_{4.7}Cl_{1.3} (Electrolyte 2).

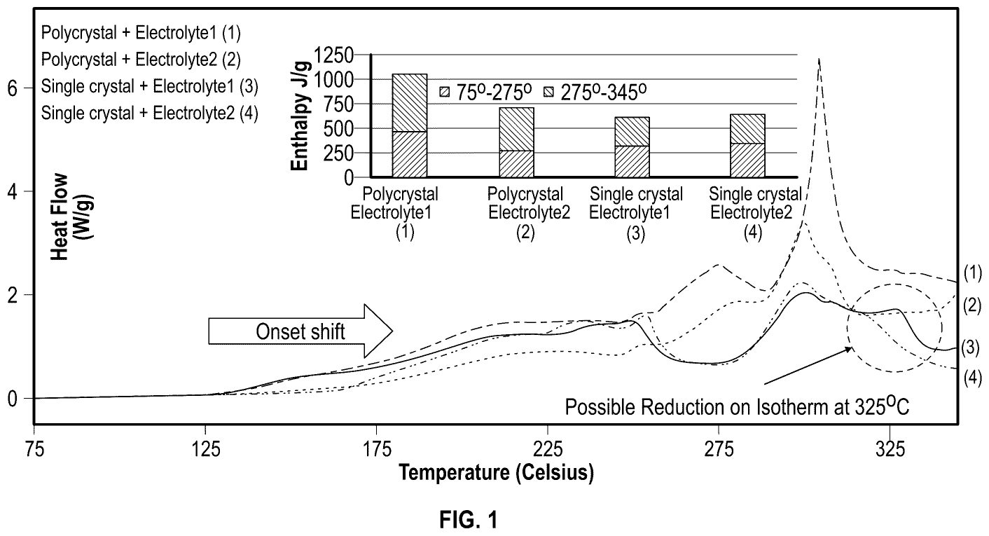

DSC results for cathodes made from single-crystal NMC622 and solid-state electrolyte, single-crystal NMC622 and solid-state electrolyte with high chloride content (Li_{5.7}PS_{4.7}Cl_{1.3} (Electrolyte 2)), polycrystalline NMC622 and solid-state electrolyte (Li₆PS₅Cl (Electrolyte 1)), and polycrystalline NMC622 and solid-state electrolyte with high chlorine content are shown in FIG. 1.

FIG. 1 shows lower maximum heat flow and total change in enthalpy (energy release) for single crystal (xtal) vs. polycrystalline NMC622. FIG. 1 also shows self-heating onset temperature shift of solid-state electrolyte with higher chlorine content (Electrolyte 2) is lower than the onset temperature of solid-state electrolyte with lower chlorine content (Electrolyte 1). A possible reduction on isotherm at 325° C. was seen for single-crystal cathode NMC622.

Referring to FIG. 1, a comparison of plot (1) and plot (3) reveal the effect of the cathode active material when the electrolyte is kept constant. The onset of the temperature rise remained the same between these two examples but the overall heat flow after around 160° C. is lower for the single crystal (plot (3)) compared to polycrystalline (plot (3)). This difference is most notable around 275° C. and 360° C.

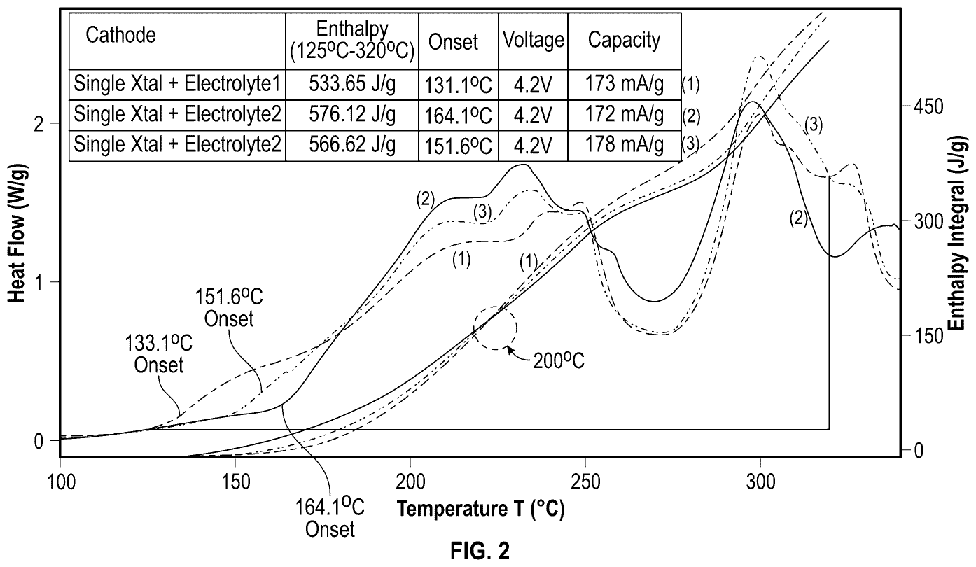

Referring to FIG. 1, the plot (1) and plot (3) examples both have a lower onset temperature as compared to high chlorine solid-state electrolyte (plot (4)) and low chlorine solid-state electrolyte (plot (2)). This shows that using an electrolyte with a higher halogen content shifts the onset temperature regardless of the NMC material used. In these examples, Electrolyte 1 refers to an electrolyte with the chemical formula Li₆PS₅Cl while Electrolyte 2 refers to an electrolyte with the chemical formula Li_{5.7}PS_{4.7}Cl_{1.3}. FIG. 2 provides the sum of the enthalpy from 125° C. to 320° C. as well as the onset temperature of single-crystal NMC622 with either Electrolyte 1 or Electrolyte 2.

This result unexpectedly shows that an increase in the halogen content of the electrolyte (Electrolyte 2) used in the cathode composite, results in a higher onset temperature and lower enthalpy (lower/less reactivity between the cathode active material and the electrolyte).

### Example 2—Blend Single Crystal Cathode Active Material and Poly-Crystalline Cathode Active Material

A cathode composition made by blending single-crystal NMC with polycrystalline NMC was also tested.

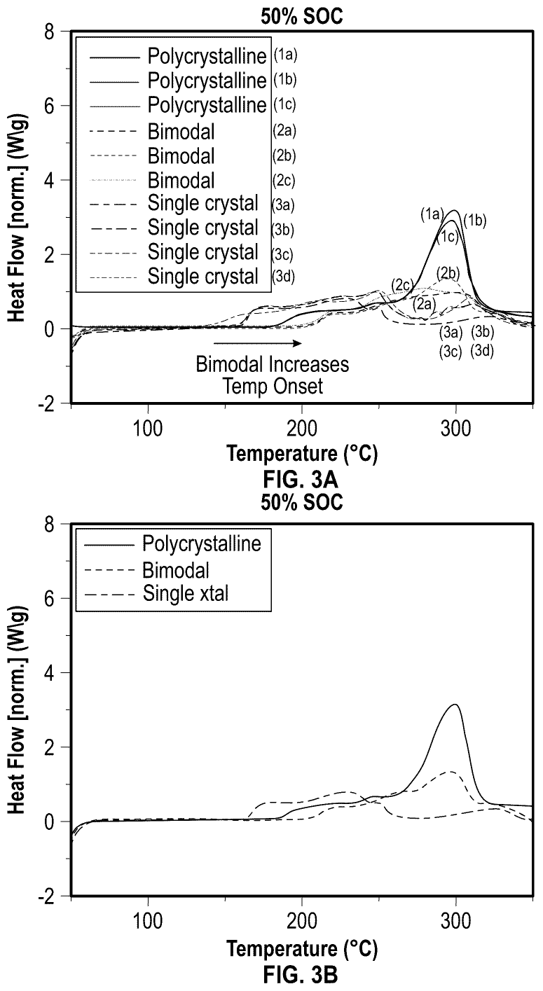

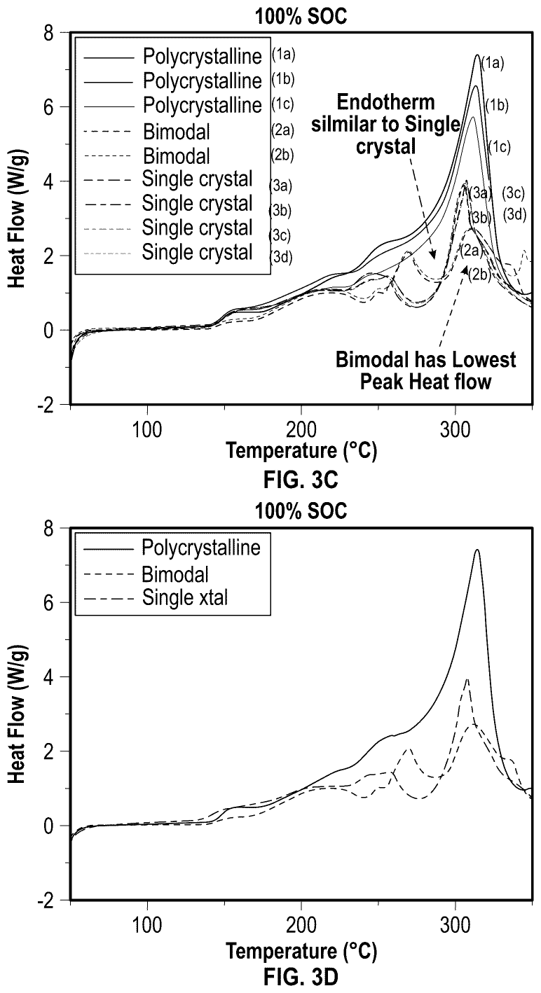

FIGS. 3A-3B show the enthalpy of cathode composites that were at 50% state of charge (had 50% of their normal amount of lithium removed). The single-crystal samples (plots 3a-3c) show that the onset temperature is around 160° C. but has the cathode material has a relatively low heat flow. The polycrystalline cathode (plots 1a-1c) had a slightly higher onset temperature of about 180° C. but had a higher heat flow, especially between 270° C. and 325° C. Lastly, there are the bimodal samples (plots 2a-2c) where the NMC composite was a mixture of 50% single-crystal and 50% polycrystalline NMC. In these examples, the onset temperature is higher than both the composite using only polycrystalline NMC or single crystal NMC—an unexpected synergistic effect. The overall heat flow of the bimodal material is more comparable to the single-crystal material rather than to an expected averaged result.

FIGS. 3C-3D shows the enthalpy of cathode composites that were at 100% state of charge (had 100% of their normal amount of lithium removed). The overall heat flow of the bimodal material is comparable to the single-crystal material, but the bimodal samples have the lowest peak heat flow. The expected result would have been the proportional average between that of a single-crystal only cathode and of a polycrystalline only cathode.

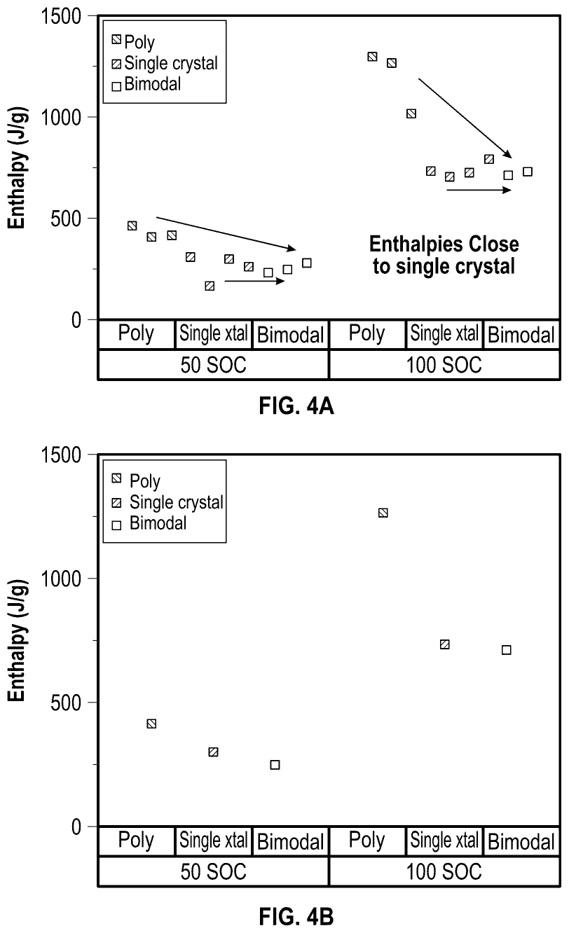

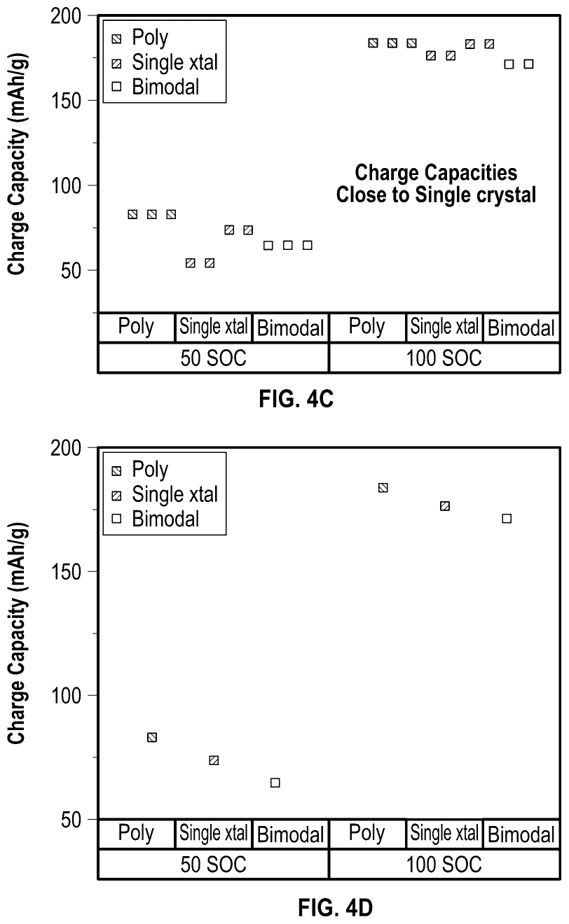

FIGS. 4A-4B shows data from the FIGS. 3A-3B summarized differently. The single-crystal NMC showed lower enthalpies than the polycrystalline NMC at SOC (state of charge) of both 50% and 100%. Surprisingly, the bimodal 50:50 blends of the two NMCs showed enthalpies similar too and, in some cases, lower than the single-crystal NMC. The expected value would have been an average value of polycrystalline and single-crystal.

FIGS. 4C-4D shows a capacity chart of cathode materials of single crystal, polycrystalline NMC, and a 50:50 blend of the single-crystal and polycrystalline NMC. FIG. 4B shows expected results as the bimodal samples have a capacity closer to an average, if not slightly lower.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations, and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

As used herein, the terms “a,” “an,” and “the” are understood to encompass the plural as well as the singular. Thus, the term “a mixture thereof” also relates to “mixtures thereof” and the term “a component” also refers to “components.”

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. patent law. “Consisting essentially of” or “consists essentially of” have the meaning generally ascribed to them by U.S. patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open-ended term, like “comprising” or “including,” it is understood that direct support should be afforded also to “consisting essentially of” language as well as “consisting of” language as if stated explicitly and vice versa.

As used herein “partially re-lithiate” refers to the process in which lithium is reintroduced or inserted into a structure to a limited extent, such that only a portion of the lithium previously lost is restored, rather than fully replacing the lithium that was originally present.

What is claimed is:

1. A cathode composite composition comprising a single-crystal cathode active material, a polycrystalline cathode active material, and one or more solid electrolyte materials, wherein the one or more solid electrolyte is a solid sulfide electrolyte comprising the formula Li_{7-y}PS_{6-y}X_{y}, where 0≤y≤2 and X is halogen, and halogen comprises F, Cl, Br, or I.

2. The cathode composite composition of claim 1, wherein the solid sulfide electrolyte is Li₆PS₅Cl.

3. The cathode composite composition of claim 1, wherein the solid sulfide electrolyte is Li_{5.7}PS_{4.7}Cl_{1.3}.

4. The cathode composite composition of claim 1, wherein the solid sulfide electrolyte is Li_{5.5}PS_{4.5}Cl_{1.5}.

5. The cathode composite of claim 1, wherein the solid electrolyte material is an argyrodite electrolyte.

6. The cathode composite composition of claim 1, wherein the single-crystal cathode active material is monolithic.

7. The cathode composite composition of claim 1, wherein the composition has a heat flow of 2.5 W/g or less between 275° C. and 325° C. when measured by DSC.

8. The cathode composite composition of claim 1, wherein the composition has an ionic conductivity of at least 2 mS/cm.

9. The cathode composite composition of claim 1, wherein the composition has an ionic conductivity of at least 3 mS/cm.

10. The cathode composite composition of claim 1, wherein the composition has an ionic conductivity from about 3 mS to about 6 mS/cm.

11. The cathode composite composition of claim 1, wherein the composition partially re-lithiates at a temperature of about 150° C. and about 300° C.

12. The cathode composite composition of claim 1, further comprising Al₂O₃.

13. The cathode composite composition of claim 1, wherein the composition has a capacity of greater than 130 mAh/g.

14. The cathode composite composition of claim 1, wherein the composition has an enthalpy from about 500 J/g to about 750 J/g at a temperature of between about 120° C. to about 350° C. and a 100% state of charge (SOC).

15. The cathode composite composition of claim 1, wherein the composition comprising the solid sulfide electrolyte with y≥0.25 has a higher onset temperature relative to a composition consisting of a solid sulfide electrolyte with y=0.

16. The cathode composite composition of claim 1, wherein the composition comprises a blend of solid sulfide electrolyte, wherein the blend comprises two or more solid-state electrolytes with different values of y.

17. The cathode composite composition of claim 1, wherein the ratio of single crystal cathode active material to polycrystalline cathode active material is from about 20:1 to about 1:20, from about 10:1 to about 1:10, from about 5:1 to about 1:5, from about 4:1 to about 1:4, from about 3:1 to about 1:3, from about 2:1 to about 1:2, from about 1.5:1 to about 1:1.5, from about 1.3:1 to about 1:1.3, from about 1.2:1 to about 1:1.2, from about 1.1:1 to about 1:1.1, or about 1:1.

18. The cathode composite composition of claim 1, wherein the composition comprising a blend of single-crystal cathode active material and polycrystalline cathode active material has a higher onset temperature relative to a composition consisting of the single-crystal electrolyte.

19. The cathode composite composition of claim 1, wherein the composition comprising a blend of single-crystal cathode active material and polycrystalline cathode active material has a higher onset temperature relative to a composition consisting of the single-crystal electrolyte or the polycrystalline cathode active material individually at 50% state of charge.

20. The cathode composite composition of claim 1, wherein the composition comprising a blend of the single-crystal cathode active material and the polycrystalline cathode active material has a lower peak heat flow relative to the composition consisting of the single-crystal cathode active material or the polycrystalline cathode active material individually at 100% state of charge.

21. The cathode composite composition of claim 1, wherein the cathode active material further comprises nickel.

22. The composition of claim 21, wherein the cathode active material comprises a nickel compound of the formula LiNiₐMn_{b}Co_{c}O₂ where 0<a<1, 0<b<1, 0<c<1 and a+b+c=1.

23. The composition of claim 21, wherein the composition comprises NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof.

24. A cathode composite composition comprising a single-crystal cathode active material.

25. The cathode composite of claim 24, further comprising one or more solid electrolyte materials, wherein the one or more solid electrolyte is a solid sulfide electrolyte comprising the formula Li_{7-y}PS_{6-y}X_{y}, where 0≤y≤2 and X is halogen, and halogen comprises F, Cl, Br, or I.

26. A cathode composite composition comprising a single-crystal cathode active material, a polycrystalline cathode active material, or a blend of a single-crystal cathode active material and a polycrystalline cathode active material.

27. The cathode composite of claim 27, further comprising one or more solid electrolyte materials, wherein the one or more solid electrolyte is a solid sulfide electrolyte comprising the formula Li_{7-y}PS_{6-y}X_{y}, where 0≤y≤2 and X is halogen, and halogen comprises F, Cl, Br, or I.

28. A cathode composite composition comprising a solid-state electrolyte, wherein the solid-state electrolyte is a solid sulfide electrolyte comprising the formula Li_{6-y}PS_{5-y}X_{1+y}, where y≥0.25 and X is halogen, and halogen comprises F, Cl, Br, or I.

29. The cathode composite composition of claim 28, wherein y≥0.30, y≥0.40, y≥0.50, y≥0.60, y≥0.70, y≥0.75, y≥1.00, y≥1.25, y≥1.50, y≥1.75, or y≥1.92.

30. The cathode composite composition of claim 28, wherein the solid sulfide electrolyte is Li_{5.7}PS_{4.7}Cl_{1.3}.

31. The cathode composite composition of claim 28, wherein the solid sulfide electrolyte is Li_{5.5}PS_{4.5}Cl_{1.5}.

32. The cathode composite composition of claim 28, wherein the electrolyte is an argyrodite electrolyte.

33. The cathode composite composition of claim 28, further comprising a single-crystal cathode active material (CAM), a polycrystalline cathode active material, or a combination thereof.

34. The cathode composite composition of claim 33, wherein the ratio of single-crystal cathode active material to polycrystalline cathode active material is from about 20:1 to about 1:20, from about 10:1 to about 1:10, from about 5:1 to about 1:5, from about 4:1 to about 1:4, from about 3:1 to about 1:3, from about 2:1 to about 1:2, from about 1.5:1 to about 1:1.5, from about 1.3:1 to about 1:1.3, from about 1.2:1 to about 1:1.2, from about 1.1:1 to about 1:1.1, or about 1:1.

35. The cathode composite composition of claim 33, wherein the composition comprising a blend of single-crystal electrolyte and polycrystalline cathode active material has a higher onset temperature relative to a composition consisting of the single-crystal cathode.

36. The cathode composite composition of claim 33, wherein the composition comprising a blend of single-crystal electrolyte and polycrystalline cathode active material has a higher onset temperature relative to a composition consisting of the single-crystal cathode active material or the polycrystalline cathode active material individually at 50% state of charge.

37. The cathode composite composition of claim 33, wherein the composition comprising a blend of the single-crystalline cathode active material and the polycrystalline cathode active material has a lower peak heat flow relative to the composition consisting of the single-crystal cathode active material or the polycrystalline cathode active material individually at 100% state of charge.
